(19) United States
(12) Patent Application Publication
(10) Pub. No.: US 2002/0080410 A1
(43) Pub. Date: Jun. 27, 2002

(54) Scanning system and method of using same

(76) Inventors: Chang-Hwa Yang, Taipei (TW); Tzan-Sheng Yang, Ching-Shui Chen (TW)

Correspondence Address: J.C. Patents, Inc., Suite 114, 1340 Reynolds Ave., Irvine, CA, 92614, US

(21) Appl. No.: 09/789,258

(22) Filed: Feb. 20, 2001

(30) Foreign Application Priority Data
Dec. 27, 2000 (TW) 89127923

(51) Int. Cl. H04N 1/00

(52) U.S. Cl. 358/400

(57) ABSTRACT

A scanning system including a scanner and a local user computer, wherein the scanner is coupled with a remote computer by a networking connection. The scanner scans objects and uploads scanned images to the remote computer directly through the networking connection. The local user computer is coupled with the scanner and the remote computer, wherein the local user computer contains an application for assigning a storage address located in the remote computer, and a driver that instructs the scanner to perform certain operations including scanning and uploading images to the assigned storage location. The remote computer wraps received data, the image files from the scanner, into a data package and saves it as a file to the assigned storage location therein. Besides assigning storage locations for saving image files, the application on the local user computer also provides the scanner with information regarding the location of the remote computer, such as internet addresses, web sites, or network locations. The driver loaded on the local user computer instructs the scanner to perform the operations mentioned above.

### CROSS-REFERENCE TO RELATED APPLICATION

This application claims the priority benefit of Taiwan application serial no. 89127923, filed Dec. 27, 2000.

### BACKGROUND OF THE INVENTION

1. Field of Invention

The present invention relates to an image scanning system. More particularly, the present invention relates to an image scanning system for directly uploading images to a remote destination and the method of using the same.

2. Description of Related Art

As referred to in FIGS. 1 and 2, a conventional method for scanning images, and then storing the scanned images to a remote destination, includes first storing the scanned images at a local user storage device 16, and then uploading the images from the local user storage device 16 to a remote destination 30. A scanning application 14 on a local user computer 10 is first executed to start the scanning process. A command is then sent to the scanner 20 from the scanning application 14, Step S100 of FIG. 2. After receiving the command from the scanning application 14, the scanner 20 starts scanning the designated object, Step S102, and then sending the scanned image to a local user storage device 16, Step S104. If the final destination for storing the scanned image is a remote storage device, such as a remote server 30, the local user computer 10 has to execute an uploading application 18 to do so, as shown in Steps S106 to S108 of FIG. 2.

According to the foregoing, the conventional method for performing scanning at a local user computer and then storing scanned images at a remote storage device has the following drawbacks:

1. It takes the local user computer extra processing time to scan and upload the images. Even though both the scanning and uploading tasks can be done in the background while the local user computer is running other application, they will still slow down the system and therefore, degrade the performance of the local user computer.

2. It takes a lot of storage space for storing temporary image files. Because image files have to be stored at the local user computer before being uploaded to the remote destination, redundant storage space at the local user computer is required.

### SUMMARY OF THE INVENTION

Accordingly, one object of the present invention is to provide a scanning system for scanning objects by using a local user computer and a scanner, and thereafter uploading the scanned images from the scanner directly to a remote destination without consuming unnecessary system resources of the local user computer.

Another object of the invention is to provide an executable program for controlling the operations performed by the scanner, including scanning objects and uploading scanned images to a designated remote location.

It is also another object of the invention to provide an application for designating the destination where the scanned images are to be stored, wherein the application can be a windowing application containing data entries for inputting information regarding the destination.

To achieve these and other advantages and in accordance with the purpose of the invention, as embodied and broadly described herein, the invention provides a scanning system including a scanner and a local user computer, wherein the scanner is coupled with a remote computer with a networking connection. The scanner scans objects and uploads scanned images to the remote computer directly through the networking connection. The local user computer is coupled with the scanner and the remote computer, wherein the local user computer contains an application for assigning a storage address located in the remote computer, and a driver that instructs the scanner to perform certain operations including scanning and uploading images to the assigned storage location, The remote computer wraps received data, the image files from the scanner, into a data package and saves it as a file to the assigned storage location therein. Besides assigning storage locations for saving image files, the application on the local user computer also provides the scanner with information regarding the location of the remote computer, such as internet addresses, web sites, or network locations. The driver loaded on the local user computer instructs the scanner to perform the operations mentioned above.

The executable program of the invention, which can be a windowing application or a browser plug-in, includes an address bar, a file toolbox and a scan toolbox. A user can key in the network address of a remote location, where the images are going to be stored, in the address bar. The file toolbox provides instruction options such as saving image files to a designated location. The scan toolbox, on the other hand, provides instruction options regarding scanning of the images.

The method of the invention for scanning images includes first giving the network address of a remote computer, designating the location within the storage device of the remote computer where images are to be stored, giving an instruction to scan images and uploading scanned images to the destination. The information about the remote destination is sent to and then stored in the scanner. Therefore, after an instruction for scanning is received by the scanner, the scanner scans the objects and uploads the scanned images directly to the remote destination.

In the preferred embodiment of this invention, the connection between the scanner and the remote computer can be an internet connection, that is, the scanner contains an interface ready for internet access.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide further understanding of the invention, and are incorporated in and constitute a part of this specification. The drawings illustrate embodiments of the invention and, together with the description, serve to explain the principles of the invention.

In the drawings,

FIG. 1 is a block diagram showing a conventional scanning system;

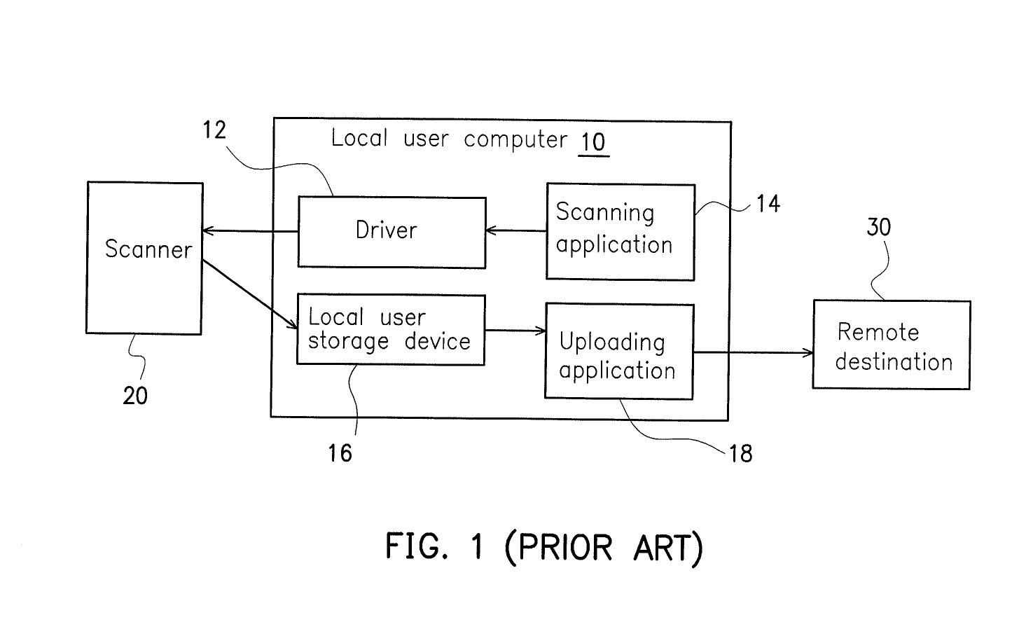

FIG. 2 is a flow chart showing a conventional method scanning and uploading images;

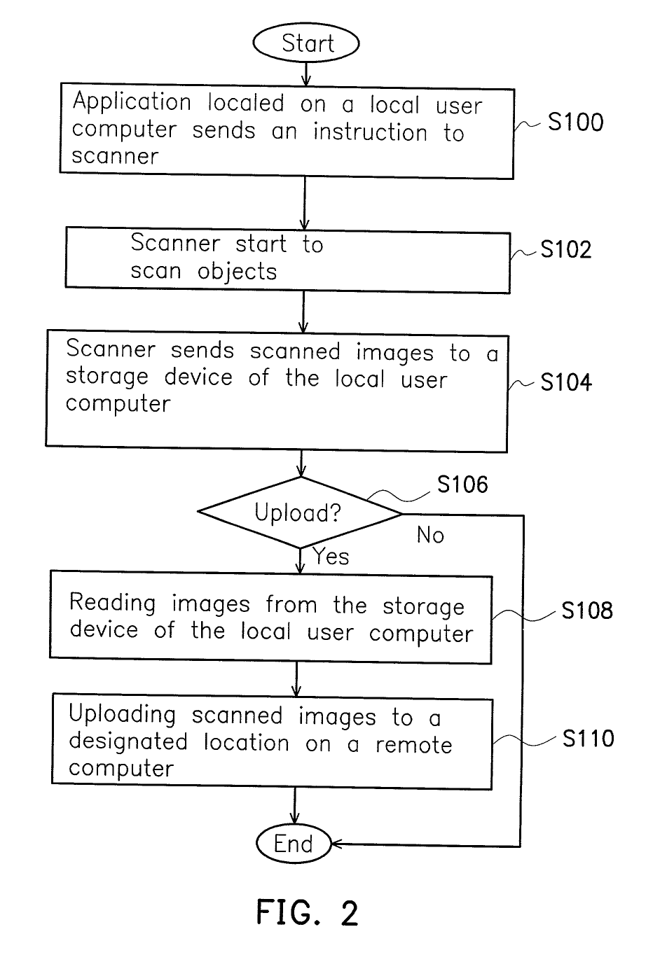

FIG. 3 is a block diagram showing a scanning system according to an embodiment of this invention;

FIG. 4 is a schematic view of a windowing application according to the embodiment of this invention; and

FIG. 5 is a flow chart showing a method for scanning and uploading images according to the embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

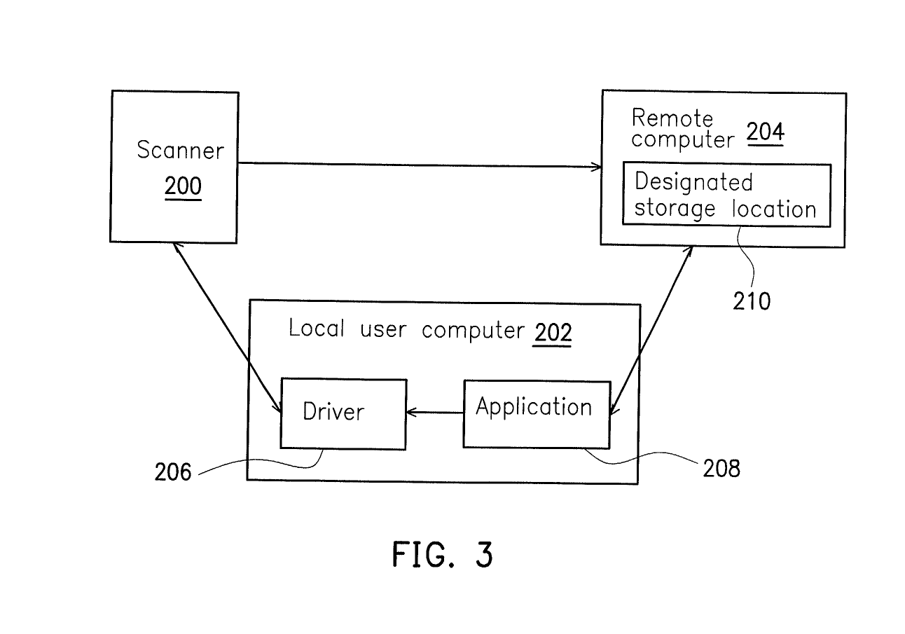

Referring to FIG. 3, the scanning system of this invention includes a scanner 200 and a local user computer 202. A user can upload scanned images from the scanner directly to a storage location 210 of a remote computer 204.

The scanner 200 of the invention is coupled with the remote computer 204 by employing a network connection, which is preferably an internet connection. Remote computer 204 can be a server or just an ordinary personal computer with network capability. Local user computer 202 is coupled with both the scanner 200 and the remote computer 204 with network connections, wherein the local user computer 202 has an application 208 and a driver 206 loaded thereon. Through the application 208, a user can assign a storage location 210 located on the remote computer 204, and through the driver 206, instruct the scanner 200 to perform scanning and uploading operations. The connections between the scanner 200 and the remote computer 204, and between the remote computer 204 and local user computer 202 can be internet connections, or other available networking connections. In order to enable the scanning system of the invention, the scanner 200 contains an interface, which has network-access capability. The interface can be either built-in or attached.

Remote computer 204 receives data from the scanner 200, wraps the data into a package and saves the package at the previously designated storage location 210. Users can then either deliver the scanned images directly from the remote computer 204 to other remote guest computers through, for example, e-mail, or print out images using remote printers.

The application 208 loaded on the local user computer provides an entry field so users can designate a remote location 210 where the images are to be stored. The application 208 also provides an entry field so users can input information regarding the network address of the remote computer 204. The driver 206, on the other hand, controls the scanner 200 to perform the scanning and uploading operations that are instructed by the application 208 loaded on the local user computer 202.

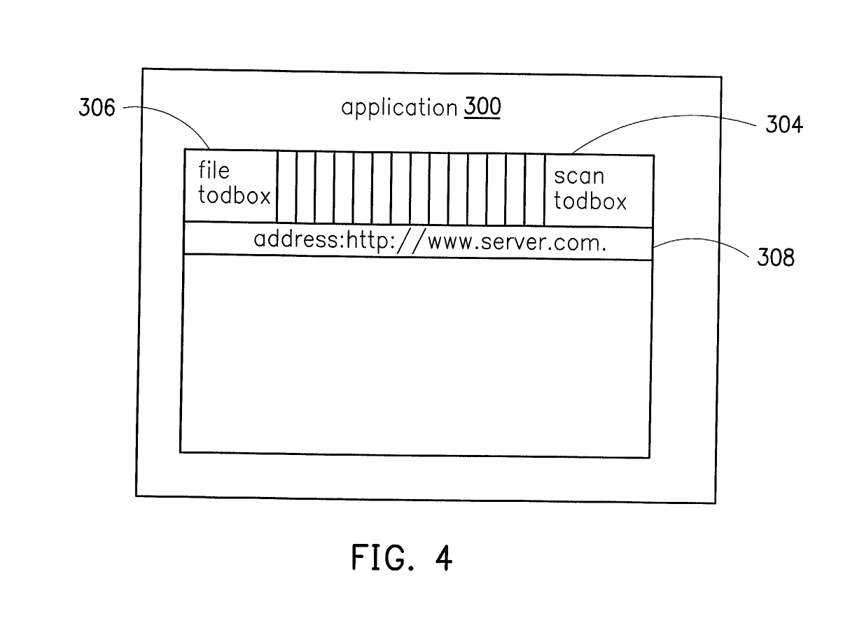

As shown in FIG. 4, the application 208 of FIG. 3 can be an internet browser plug-in 300, wherein the plug-in 300 contains at least an address row 308, a file toolbox 306 and a scan toolbox 304. The address row 308 is for receiving the address information for a remote computer 204 of FIG. 3, from a user. The file toolbox 306 is used for assigning a storage location 210 on the remote computer 204. The scan toolbox 304 is used for sending an instruction to the scanner 200 to start the operations of scanning and uploading images to the remote destination assigned by the file toolbox 306.

Once the scanner 200 receives an instruction from the local user computer 202, it will perform the desired scanning operation, and then directly upload the scanned images to a designated location 210 according to the information provided by the address row 308 and the file toolbox 306. The connection between the scanner 200 and the remote computer 204 can be an internet connection, or other available network connection.

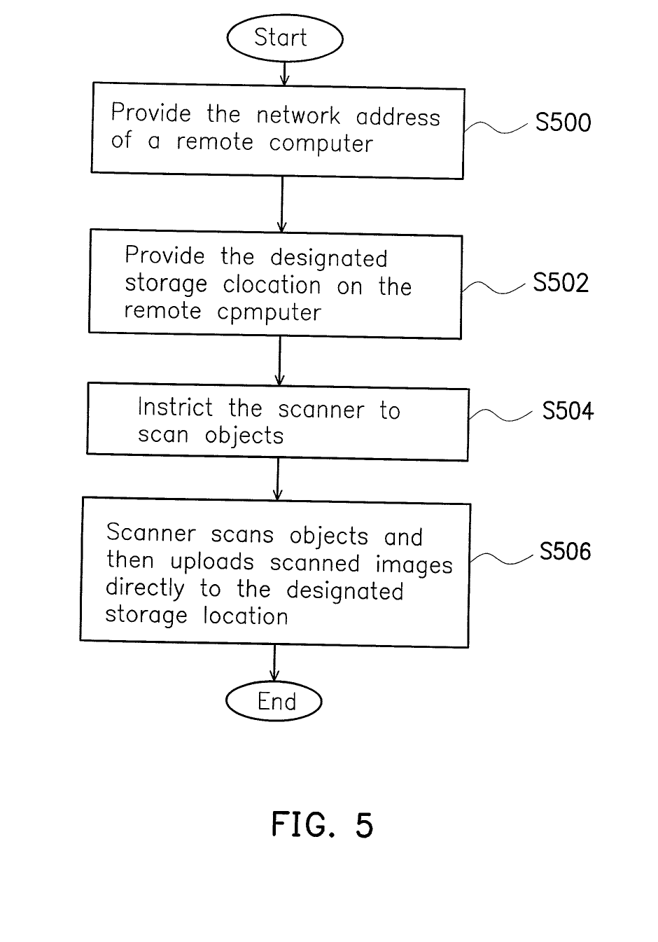

As referred to in FIG. 5, the method for scanning and uploading images to a remote location starts with Step S500, providing the address row 308 with the network address of a designated remote computer. Then, as shown in Step S502, a designated storage location, on the remote computer, for storing the scanned images, is entered into the file toolbox 306. After the scan toolbox is selected, Step S504, the scanner 200 starts to scan objects and then upload the scanned images directly to the remote location, Step S506. The scanner 200 of the invention handles all of the scanning and uploading tasks, without consuming unnecessary system resources of the local user computer, such as CPU processing time and storage space.

According to the foregoing, the scanning system of the invention has the following advantages:

1. The scanning system of the invention does not take much of the CPU processing time of the local user computer for processing and uploading scanned images because most of these tasks are to be handled by the scanner.

2. The scanning system of the invention does not take up redundant storage space for storing scanned images. Instead, the scanning system of the invention directly uploads scanned images from the scanner to a remote destination.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A scanning system for scanning an object and then uploading a scanned image to a destination on a remote computer, the scanning system comprising:
a scanner, connected to the remote computer with a connection, wherein the scanner scans the object and then uploads the scanned image to the remote computer through the connection;
a local user computer, connected to the scanner and the remote computer respectively;
an application, loaded on the local user computer, for providing the scanner with an address of the destination and a network address of the remote computer; and
a driver, loaded on the local user computer, for driving the scanner to perform a plurality of operations.

2. The scanning system of claim 1, wherein the scanned image is first wrapped as a package by the remote computer.

3. The scanning system of claim 2, wherein the package is stored at the destination.

4. The scanning system of claim 1, wherein the scanned image is sent to a remote guest computer from the remote computer.

5. The scanning system of claim 1, wherein the scanned image is printed out through a remote printer.

6. The scanning system of claim 1, wherein application further comprises a first entry for receiving the address of the destination, and a second entry for receiving the network address of the remote computer.

7. The scanning system of claim 1, wherein the address of the destination and the network address of the remote computer are sent to the scanner from the local user computer by an application.

8. The scanning system of claim 1, wherein the driver drives the scanner to perform a scanning operation and an uploading operation.

9. The scanning system of claim 8, wherein the uploading operation comprises storing the scanned image to the destination according to the address of the destination and the network address of the remote computer.

10. The scanning system of claim 1, wherein the connection includes an internet connection.

11. The scanning system of claim 1, wherein the local user computer and the remote computer are connected with an internet connection.

12. A scanning application, comprising:
an address row, for receiving a network address of a computer;
a file toolbox, for receiving an address of a storage destination on the computer; and
a scan toolbox, for instructing a scanner to perform a scanning operation and an uploading operation, wherein the scanner uploads an image to the storage destination of the computer.

13. The scanning application of claim 12 is a windowing application.

14. The scanning application of claim 12, wherein the scanner and the computer are coupled with an internet connection.

15. A scanning method of uploading a scanned image to a storage destination of a remote computer by using a scanner and an application, the scanning method comprising steps of:
providing the application with a network address of the remote computer;
providing the application with a storage address of the storage destination; and
providing the scanner with a scanning instruction.

16. The method of claim 15, wherein the scanning instruction contains the network address and the storage address.

17. The method of claim 16, wherein the scanner obtains the scanned image and then uploads the scanned image to the destination according to the network address and the storage address, upon receipt of the scanning instruction.

18. The method of claim 16, wherein the remote computer and the scanner are coupled with an internet connection.
